(19) United States
(12) Patent Application Publication
(10) Pub. No.: US 2021/0278564 A1
(43) Pub. Date: Sep. 9, 2021

(54) DYNAMIC FLOOD RISK DATA MANAGEMENT

(71) Applicant: International Business Machines Corporation, Armonk, NY (US)

(72) Inventors: Su Liu, Austin, TX (US); Howard N. Anglin, Leander, TX (US); Sushain Pandit, Austin, TX (US)

(21) Appl. No.: 16/809,678

(22) Filed: Mar. 5, 2020

(51) Int. Cl. G01W 1/10; G16Y 40/10; G16Y 20/10; G16Y 20/30

(52) U.S. Cl. CPC G01W 1/10; G16Y 20/30; G16Y 20/10; G16Y 40/10

(57) ABSTRACT

A system, method, and computer program product for managing flood risk analysis. The system includes at least one processing component, at least one memory component, and a data manager configured to define a ledger for a zone, and extract flood data for the zone from at least one information source. The system also includes a risk analyzer configured to generate flood attribute values based on the extracted flood data. The risk analyzer is also configured to calculate a zone risk score based on these values, determine that the zone risk score is above a threshold risk score, and in response, instruct the data manager to add a block to the ledger.

### BACKGROUND

The present disclosure relates to flood risk analysis for locations in a monitored zone and, more specifically, to managing flood risk analysis in a distributed ledger.

Floods are one of the most common causes of property damage in the United States. However, the likelihood of a flood occurring varies based on location. Flood risk analysis can be used to determine whether flood insurance should be obtained for a property. Flood risk analyses are commonly based on information in a flood map database maintained by the Federal Emergency Management Agency (FEMA). This flood map database indicates different levels of flood risk for zones that have been evaluated by FEMA. In some high risk zones, flood insurance is required by law. In other zones covered by FEMA's flood map database, flood insurance recommendations can be made based on flood estimation reports carried out by title companies, home loan providers, etc.

### SUMMARY

Various embodiments are directed to a system that includes at least one processing component, at least one memory component, and a data manager configured to define a ledger for a zone, and extract flood data for the zone from at least one information source (e.g., weather data and/or insurance claims). The system also includes a risk analyzer configured to generate flood attribute values based on the extracted flood data. The risk analyzer is also configured to calculate a zone risk score based on these values, determine that the zone risk score is above a threshold risk score, and in response, instruct the data manager to add a block to the ledger. In some embodiments, the risk analyzer is configured to calculate a location risk score based on the zone risk score and user-input information (e.g., a lot drainage type) about the location. The system can also include a report generator configured to generate a risk report for the location. Additionally, the data manager can be configured to extract additional flood data for the zone. The risk analyzer can then generate additional flood attribute values based on the additional data, calculate an updated zone risk score, and determine that the updated zone risk score is outside a threshold risk score range. In response, the data manager can instruct the data manager to add a next block to the ledger.

Further embodiments are directed to a method that includes defining a ledger for a zone, extracting flood data for the zone from at least one information source (e.g., weather data and/or insurance claims), and generating flood attribute values based on the extracted flood data. The method also includes calculating a zone risk score based on the flood attribute values, determining that the zone risk score is above a threshold risk score, and in response, adding a block to the ledger. The method can also include calculating a location risk score for a location based on the zone risk score and user-input information (e.g., a lot drainage type) about the location, and generating a risk report for the location. Further, the method can include extracting additional flood data for the zone, generating additional flood attribute values based on the additional data, and calculating an updated zone risk score. The method can also include determining that the updated zone risk score is outside a threshold risk score range, and in response, adding a next block to the ledger.

Additional embodiments are directed to a computer program product that includes a computer readable storage medium having program instructions that are executable by a processor to cause a device to perform a method that includes defining a ledger for a zone, extracting flood data for the zone from at least one information source (e.g., weather data and/or insurance claims), and generating flood attribute values based on the extracted flood data. The method also includes calculating a zone risk score based on the flood attribute values, determining that the zone risk score is above a threshold risk score, and in response, adding a block to the ledger. The method can also include calculating a location risk score for a location based on the zone risk score and user-input information about the location, and generating a risk report for the location. Further, the method can include extracting additional flood data for the zone, generating additional flood attribute values based on the additional data, and calculating an updated zone risk score. The method can also include determining that the updated zone risk score is outside a threshold risk score range, and in response, adding a next block to the ledger.

### BRIEF DESCRIPTION OF THE DRAWINGS

FIG. 1 is a block diagram illustrating a flood risk data management environment, according to some embodiments of the present disclosure.

FIG. 2A is a flow diagram illustrating a process of managing flood risk data, according to some embodiments of the present disclosure.

FIG. 2B is a flow diagram illustrating a process of generating a flood risk report, according to some embodiments of the present disclosure.

FIG. 3 is a block diagram illustrating a computer system, according to some embodiments of the present disclosure.

FIG. 4 is a block diagram illustrating a cloud computing environment, according to some embodiments of the present disclosure.

FIG. 5 is a block diagram illustrating a set of functional abstraction model layers provided by the cloud computing environment, according to some embodiments of the present disclosure.

### DETAILED DESCRIPTION

Floods are a common cause of property damage in many areas, including the United States. However, the likelihood of a flood occurring varies based on location. Geographical areas can be divided into zones, each zone having a different level of flood risk. These zones can be defined by the Federal Emergency Management Agency (FEMA) in a flood map database.

However, there are many zones that have not been evaluated, and therefore have unknown levels of flood risk. Additionally, the flood map database is updated infrequently (e.g., every 5-15 years) in many areas. Therefore, it can be difficult to determine whether to obtain flood insurance for a property in zones where flood insurance is not required by law. It can also be difficult to obtain more detailed or precise flood information about a specific property than the level of risk associated with its entire zone. For example, current techniques for determining flood risk do not take into account factors such as local terrain and building features (e.g., whether a building has an entrance on an uphill or downhill side of a hill).

Disclosed herein are techniques for generating and updating a ledger with flood data (e.g., data collected from FEMA, insurance claims, news and/or social media reports, weather forecasts, etc.) for a defined and monitored zone. The ledger can be a distributed ledger, which is a ledger that is spread across multiple nodes on a peer-to-peer network. However, any kind of ledger can be used in some embodiments. Flood data can be added to the ledger whether or not the zone is covered by FEMA's flood map database. The ledger can be a public, private, or hybrid blockchain, and is dynamically updated as new flood data is collected. Additionally, there can be more than one ledger, each ledger corresponding to a different zone. Techniques for producing a custom flood risk report in response to a user request are also disclosed herein. The custom flood risk report includes a risk score for a property and/or location input by the user. The risk score is based on information specific to the input location and information from the ledger corresponding to the location/property's defined zone. In addition to the risk score, reports can include additional information from the ledger in order to provide a more detailed explanation of the location's flood risk. For example, additional information can include a confidence score for the risk score, sources of the monitored zone's flood data, detailed information about factors influencing the risk score, recommended insurance options, etc.

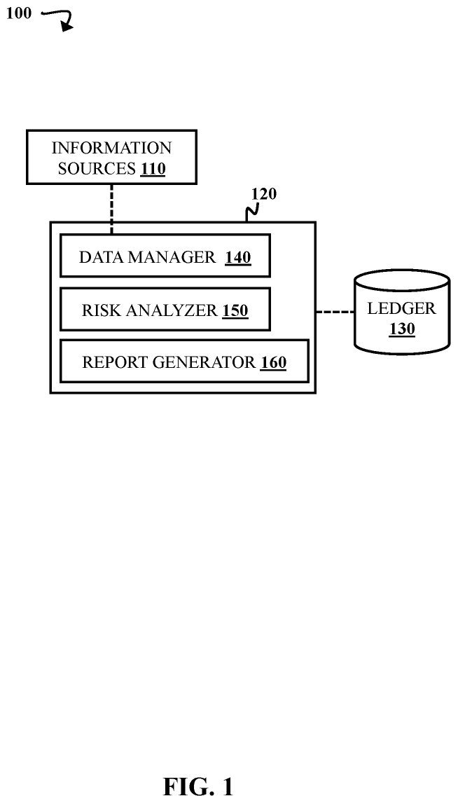

FIG. 1 is a block diagram illustrating a flood risk data management environment 100, according to some embodiments of the present disclosure. The flood risk data management environment 100 includes at least one information source (“information sources 110”), a flood analysis component 120, and a ledger 130. The flood analysis component 120 includes a data manager 140, a risk analyzer 150, and a report generator 160. In some embodiments, the data manager 140, risk analyzer 150, and report generator 160 are processor executable instructions that can be executed by a dedicated or shared processor using received inputs.

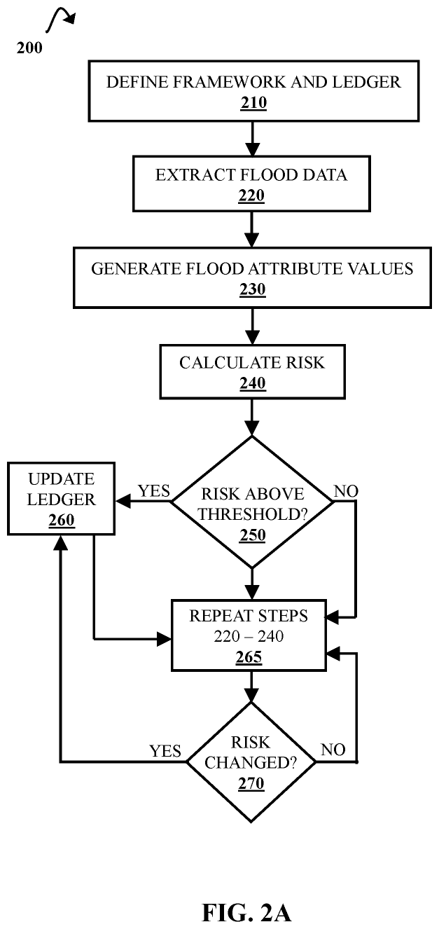

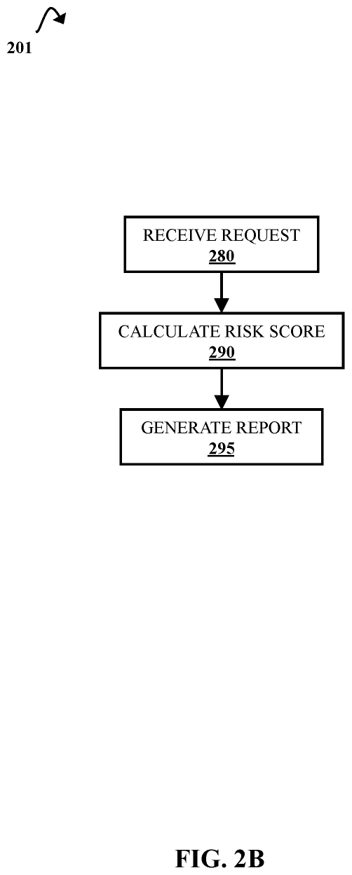

The data manager 140 defines a ledger 130 for a given zone. Herein, “zone” refers to a defined geographical area, which can have boundaries defined by a zip code, county, grid, radius from a given feature (e.g., a dam), climate, FEMA-designated zones, etc. The ledger 130 can be a blockchain-based distributed ledger, and can be a public, private, or hybrid ledger. The zone is monitored by the data manager 140, which can add blocks to the ledger 130 based on data collected for the zone. This is discussed in greater detail below. The data manager 140 also defines a framework for collecting and managing flood data for the zone. The framework can include settings for monitoring the zone (e.g., instructions for extracting flood data, converting the flood data into attribute values, techniques used to calculate risk scores, etc.), access controls for the ledger 130, threshold risk scores, etc. The framework defined by the data manager 140 is discussed in greater detail with respect to FIG. 2A.

The data manager 140 extracts flood data from the information sources 110, which can include structured and/or unstructured data. The information sources 110 can include records of meteorological data, topographical data, geomorphic data, hydrological data, elevation, etc. In some embodiments, the information sources 110 include sources of construction information, such as building records and blueprints. Examples of information sources 110 can also include insurance claims, weather forecasts, weather reports, historical records, weather station data (e.g., measurements made by rain gauges, stream gauges, thermometers, anemometers, barometers, hygrometers, level sensors, radar and/or lidar systems, satellite systems, etc.), existing flood risk calculations/reports (e.g., FEMA flood maps, National Weather Service measurements, communications from local governments), news media, user-submissions (e.g., text, photographs, videos, etc.), social networking sites, video hosting sites, blog hosting sites, etc.

Examples of extracted flood data can include weather data, environmental data, construction data, etc. from the monitored zone. For example, weather data can indicate what kind of weather events, such as heavy rain (e.g., from a severe thunderstorm, a hurricane, or a tropical storm), have occurred or are predicted to occur in the zone. In another example, environmental data can indicate environmental risk factors associated with the monitored zone, such as a river that may overflow, whether the zone is in a region affected by tsunamis, topographical information (e.g., elevation, distance from a body of water, etc.), types and locations of any dams in or around the zone, etc. The data manager 140 maps flood data for a monitored zone to other flood data for the same zone (e.g., in a mapping table). For example, the data manager 140 can map extracted weather data to flood insurance claims in the same zone. This can provide more specific information about the type of damage that can occur at a given property under particular weather conditions.

The risk analyzer 150 generates flood attribute values by converting the extracted flood data into numerical values. For example, flood attribute values can be values on a hazardousness scale (e.g., 1-5, 1-10, etc.). For example, hazardousness values can correspond to lot drainage types (e.g., split to a back lane, rear-to-front, front-to-rear, flat, low spot, etc.), dam types (e.g., embankment, masonry, diversion, etc.), etc. Different sources of heavy rain can receive values indicating their hazardousness levels. For example, on an ascending scale of hazardousness from 1-5, a severe thunderstorm, a hurricane, and a tropical storm can have respective flood attribute values of 3, 4, and 5.

In some embodiments, the risk analyzer 150 can generate flood attribute values based on numerical values in the extracted flood data. For example, flood attribute values can include the costs of flood damage (e.g., extracted from insurance claims in the monitored zone), distance measurements (e.g., kilometers between a property location input by a user and a river), weather and other environmental data (e.g., average annual rainfall in the monitored zone), etc. In some embodiments, the risk analyzer 150 can convert ranges of extracted values to flood attribute values. For example, on a scale of 1-3, flood damage costs of $0-$500, $500-$2000, and greater than $2000 can have flood attribute values of 1, 2, and 3, respectively.

Flood attribute values can also include measurements and/or scale values reported by the National Weather Service (NWS). These values can measure severity, probability of occurrence, and speed of onset of flooding. Measurements of severity can be based on magnitude, duration, and extent of flooding. For example, the NWS defines flood magnitude as a measure of total runoff volume, and assigns numbers on a scale of 0-10 to the measured values. On this scale 0 indicates that no flooding has occurred, and 10 represents the total runoff volume of the flood of record. For example, if the runoff volume for a flood (“Flood X”) is 80% of the flood of record's runoff volume, Flood X receives a value of 8.

Based on the flood attribute values, the risk analyzer 150 calculates flood risk scores for the monitored zone. The risk analyzer 150 can also provide a data confidence score for each risk score. The confidence scores can be percentages (e.g., 29% confidence, 64% confidence, 98% confidence, etc.) or any other appropriate format (e.g., a number from 1-5, 1-10, etc.). If the flood risk score and, optionally, its data confidence score for the zone are above threshold scores, the data manager 140 adds a block to the ledger 130. The block indicates the risk score and confidence score. Further, the block can indicate what factors contributed to the risk score calculation. The block can also include information such as sources 110 of the extracted flood data.

The report generator 160 generates reports providing information about the flood risk of specific locations within the monitored zone in response to user-input requests. A user (e.g., a title agent, mortgage lender, realtor, inspector, homeowner, etc.) can request a flood risk report for a given location. The request includes identification of the location (e.g., an address, a location ID, a property ID for a building or other structure in the location, selection of a point on a map, etc.). The request can also include additional user-input information about the location and/or property at the location (e.g., lot drainage type, construction information, etc.).

In response to the request, the risk analyzer 150 locates the ledger 130 for the zone containing the entered location. Based on the user-input location information and a zone risk score stored in the ledger 130, the risk analyzer 150 calculates a risk score for the entered location, which is referred to herein as a “location risk score”. The data manager 140 can define a data format for managing flood risk data, such as: REPORT_DATA [RequestID, LocationID, PropertyID, LotDrainageType, OriginaIDataSource(Ledger block #), DataConfidenceScore, FloodRiskScore].

The report generator 160 then generates the flood risk report, and delivers it to the user. The report indicates the location risk score. The report can also include a confidence score for the location risk score, extracted flood data, the most recently calculated risk score for the monitored zone and the time at which it was calculated, etc. The report can display the information as text, information graphics, maps, charts, diagrams, animations, videos, interactive displays, etc. These elements of the report can be displayed using formats such as graphics interchange format (GIF), portable network graphics (PNG), Joint Photographic Experts Group (JPEG), scalable vector graphics (SVG), vector markup language (VML), etc.

FIG. 2A is a flow diagram illustrating a process 200 of managing flood data, according to some embodiments of the present disclosure. To illustrate process 200, but not to limit embodiments, FIG. 2A is described within the context of the flood risk data management environment 100 of FIG. 1. Where elements discussed in FIG. 2A are identical to elements shown in FIG. 1, the same reference numbers are used in both Figures.

The data manager 140 defines a framework for collecting and managing flood data, and a ledger 130 for storing the flood data. This is illustrated at step 210. The data manager 140 defines the ledger 130 for a monitored zone. Zones are discussed in greater detail with respect to FIG. 1. The data manager 140 can define, for the framework, settings related to information collection, such as information sources 110 from which to extract information and the timing of intervals between information collection, type of information to collect, etc. For example, the framework can include instructions for identifying keywords related to flood information in unstructured data (e.g., news reports).

The framework can also define flood attribute values (e.g., hazardousness scale values, flood severity values, etc.), threshold risk scores, threshold confidence scores, types of flood data to collect for the monitored zone (e.g., water levels, elevation, flood insurance claims), etc. In some embodiments, the framework can be modified by a user. For example, a user can enable or disable extraction of flood data from social media sources or other sources selected from the information sources 110. In another example, a user can adjust a threshold risk score and/or confidence score.

The framework can also define access controls for the ledger 130. For example, the ledger 130 for a monitored zone can include a public ledger and a private ledger. Blocks providing flood data such as data extracted from weather reports, news reports, FEMA's flood map database, etc., can be added to the public ledger. Blocks in the public ledger can be accessed by any user. However, blocks in the private ledger 130 can be accessed only by users having the required permissions (e.g., title companies, insurance providers, FEMA, etc.). For example, blocks containing location-specific information (e.g., property addresses, user-input information, insurance information, names, etc.) can be added to the private ledger 130. In some embodiments, the framework defines permissions required to add flood data to the ledger 130. For example, FEMA may be permitted to update the ledger 130 with information from updates to FEMA's flood map database.

The data manager 140 extracts flood data from information sources 110. This is illustrated at step 220. The flood data for the monitored zone is extracted and added to the ledger 130 according to the framework defined by the data manager 140. The flood data can be information related to previous flooding and/or factors that can affect the likelihood and characteristics of a future flood. Examples of flood data that can be extracted from the information sources 110 are discussed in greater detail with respect to FIG. 1. The data manager 140 can use a variety of text, image, and/or audio analysis techniques to extract flood data. Examples of these techniques can include text pattern matching, computer vision web page analysis, remote web server requests by hypertext transfer protocol (HTTP) programming, hypertext markup language (HTML) parsing, document object model (DOM) parsing, and semantic annotation recognizing.

When flood data is in the form of text data (e.g., letters, numbers, and/or other characters) the data manager 140 can use at least one text analysis approach to extract measurable flood attributes. For example, keywords related to flood attributes, extent and/or cost of property damage, topography, etc. can be identified. Text analysis can be carried out using natural language processing techniques such as Hidden Markov models, statistical models, decision tree algorithms, supervised machine learning algorithms, semi-supervised machine learning algorithms, unsupervised machine learning algorithms, text mining, naïve Bayes classifiers, latent semantic indexing, etc.). In some embodiments, text analysis is carried out using neural networks.

The data manager 140 can also use image analysis techniques to extract flood data from graphical images of the defined zone and/or its surrounding area. The graphical images can include still images and/or videos of flooding or conditions that may result in flooding (e.g., heavy rain, topographical features, building construction, etc.). In some embodiments, the graphical images can include maps and illustrations. Image analysis techniques that can be used can include edge detection techniques, Hidden Markov models, principal component analysis, video fingerprinting, linear discriminant analysis, elastic bunch graph matching, multilinear subspace learning, dynamic link matching, and neural networks. However, any appropriate technique for analyzing images can be used. Additionally, optical character recognition (OCR) can be used to convert characters within an image to text data.

When an information source 110 includes audio data, the data manager 140 can use speech recognition or other semantic audio analysis techniques to extract flood data. Flood data can also be gathered from non-speech audio recordings. For example, an audio recording of a storm can be analyzed to determine the strength or severity of the storm (e.g., based on audio analysis of recorded wind, rain, running water, etc.). Examples of audio analysis techniques can include Hidden Markov models, dynamic time warping, neural networks, end-to-end automatic speech recognition, and audio fingerprinting algorithms.

Flood attribute values are then generated. This is illustrated at step 230. The risk analyzer 150 converts flood data extracted by the data manager 140 into the flood attribute values. The flood attribute values are numerical values that can be used to calculate a risk score. For example, flood attribute values can be numbers on a scale of hazardousness (e.g., based on extracted flood data keywords; extracted monetary values, measurements, or values assigned to ranges thereof; etc.). Examples of flood attribute values are discussed in greater detail with respect to FIG. 1.

The risk analyzer 150 then determines a flood risk for the monitored zone. This is illustrated at step 240. The flood risk for the zone includes a risk score (e.g., a percent risk) calculated by the risk analyzer 150. The risk score is calculated from the flood attribute values generated at step 230. The risk analyzer 150 can also calculate a confidence score associated with the risk score. In these instances, the flood risk for the zone can be based on the risk score and the confidence score. For example, a risk score of 60% with a confidence score of 90% would indicate a higher flood risk than a risk score of 60% with a confidence score of 20%.

It is determined whether the risk score calculated for the monitored zone is above a threshold risk score. This is illustrated at step 250. The risk analyzer 150 compares the calculated risk score to a threshold risk score. In some embodiments, the risk analyzer 150 also compares an associated confidence score with a threshold confidence score. In these instances, the risk analyzer 150 determines that the flood risk is above the threshold only when both the risk score and confidence score are above their respective threshold scores.

If the risk score is above the threshold risk score, the data manager 140 adds a block to the ledger 130. This is illustrated at step 260. However, it should be noted that in some embodiments, the block is only created when both the risk score and the confidence score are above threshold scores. The block added to the ledger 130 indicates the level of flood hazard in the monitored zone. For example, the block can include the risk score, confidence score, flood attribute values, flood data, information sources 110, etc. The block can be added to a public and/or private ledger 130, depending upon settings in the framework defined by the data manager 140.

When the ledger has been updated at step 260, or if it has been determined that the risk score is not above the threshold score at step 250, steps 220-240 are repeated. This results in the calculation of an updated risk score at step 240. It is then determined whether there has been a change in flood risk. This is illustrated at step 270. A change in flood risk can be determined based on a threshold range of risk scores defined by the data manager 140 in the framework. A change in risk can be indicated by an updated risk score that is outside a threshold range of difference values between the updated risk score and the previous risk score. For example, there can be a risk score of 50% with a threshold range of ±25%. An updated risk score of 60% would therefore not indicate a change in risk score, while an updated risk score of 80% would indicate a change. In some embodiments, the threshold change is the same for both increases and decreases in risk score. In other embodiments, there can be different thresholds for increases and decreases in risk score (e.g., 30% lower than the previous risk score to 20% higher than the previous risk score). The change in risk score can also be determined by changes in confidence score or both confidence and risk scores.

If it is determined at step 270 that the risk score has changed, process 200 proceeds again to step 260, and the ledger 130 is updated by the data manager 140 to include a next block. Examples of block contents that can be included are discussed in greater detail above. However, if the risk analyzer 150 determines that there is no change in risk as defined in the framework, process 200 repeats steps 220-240. This is illustrated at step 265. Upon completing the repetition at step 265, process 200 proceeds again to step 270. The frequency of repetition of these steps (e.g., daily, monthly, yearly, etc.) is defined by the data manager 140 in the framework. When changes are discovered at step 270, the ledger 130 is updated with a next box at 260. In other embodiments, process 200 can end after completing step 270 (e.g., if there are instructions to do so in the framework).

FIG. 2B is a flow diagram illustrating a process 201 of generating a flood risk report, according to some embodiments of the present disclosure. To illustrate process 201, but not to limit embodiments, FIG. 2B is described within the context of the flood risk data management environment 100 illustrated in FIG. 1 and the process 200 illustrated in FIG. 2A. Where elements shown in FIG. 2B are identical to elements shown in FIG. 1 or 2A, the same reference numbers are used in each Figure.

A request for a flood risk report is input by a user. This is illustrated at step 280. The flood risk report can include user-input flood data. For example, a user can enter an address of a residential building and the lot drainage type at this location. The user can also enter information about the building construction (e.g., type of drainage system, age of building, presence of a basement, etc.). Additional examples of user-input information are discussed in greater detail with respect to FIG. 1. The data manager 140 can also use the user-input information to extract additional flood data from one or more information sources 110. For example, based on an input location, the data manager 140 can extract the distance between the location and any nearby bodies of water.

A risk score is then calculated for the location indicated in the report request. This is illustrated at step 290. The risk analyzer 150 converts the location-specific flood data (e.g., user-input and/or additional extracted flood data) into flood attribute values. Additionally, the risk analyzer 150 determines which zone the location is in, and locates the ledger 130 for the zone. The risk analyzer 150 calculates a location risk score for the input location based on the zone risk score and/or flood attribute values in the ledger 130 and the flood attribute values from the location-specific flood data. The risk analyzer 150 can also calculate a confidence score for the location risk score.

The report generator 160 generates a flood risk report for the requested location. This is illustrated at step 295. The report provides the location risk score. The report can also include a location-specific confidence score, extracted flood data for the monitored zone and/or requested location, the zone risk score, the time of the most recent update to the zone risk score for the monitored zone, the confidence score for the zone risk, flood data information sources 110, etc. The report can display the information as text, information graphics, maps, charts, diagrams, animations, videos, interactive displays, etc. This is discussed in greater detail with respect to FIG. 1.

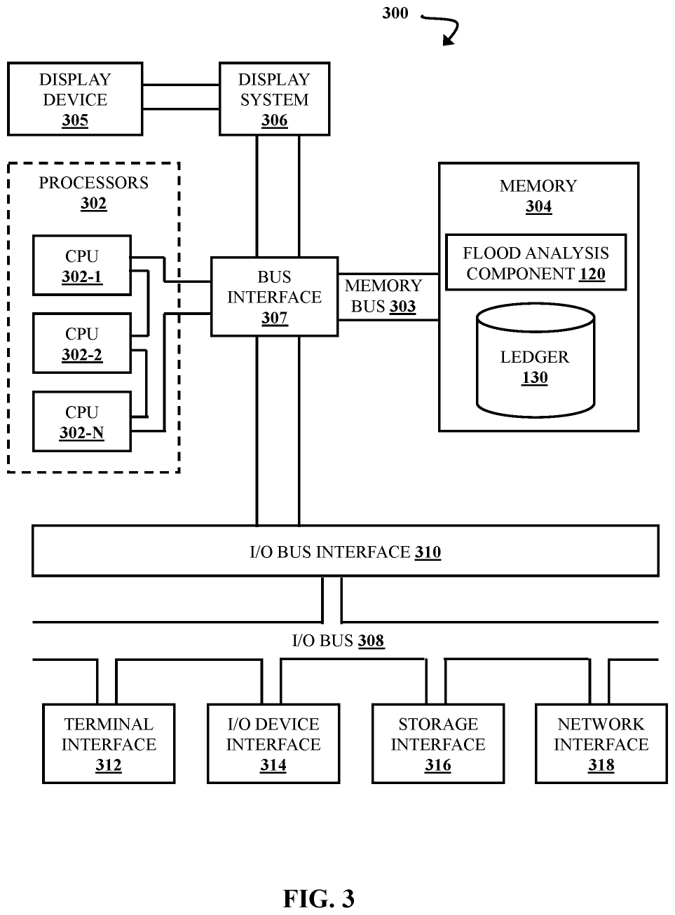

FIG. 3 is a block diagram illustrating an exemplary computer system 300 that can be used in implementing one or more of the methods, tools, components, and any related functions described herein (e.g., using one or more processor circuits or computer processors of the computer). In some embodiments, the major components of the computer system 300 comprise one or more processors 302, a memory subsystem 304, a terminal interface 312, a storage interface 316, an input/output device interface 314, and a network interface 318, all of which can be communicatively coupled, directly or indirectly, for inter-component communication via a memory bus 303, an input/output bus 308, bus interface unit 307, and an input/output bus interface unit 310.

The computer system 300 contains one or more general-purpose programmable central processing units (CPUs) 302-1, 302-2, and 302-N, herein collectively referred to as the CPU 302. In some embodiments, the computer system 300 contains multiple processors typical of a relatively large system; however, in other embodiments the computer system 300 can alternatively be a single CPU system. Each CPU 302 may execute instructions stored in the memory subsystem 304 and can include one or more levels of on-board cache.

The memory 304 can include a random-access semiconductor memory, storage device, or storage medium (either volatile or non-volatile) for storing or encoding data and programs. In some embodiments, the memory 304 represents the entire virtual memory of the computer system 300, and may also include the virtual memory of other computer systems coupled to the computer system 300 or connected via a network. The memory 304 is conceptually a single monolithic entity, but in other embodiments the memory 304 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory can be further distributed and associated with different CPUs or sets of CPUs, as is known in any of various so-called non-uniform memory access (NUMA) computer architectures. The memory 304 also contains a flood analysis component 120 and a ledger 130 (illustrated in FIG. 1).

These components are illustrated as being included within the memory 304 in the computer system 300. However, in other embodiments, some or all of these components may be on different computer systems and may be accessed remotely, e.g., via a network. The computer system 300 may use virtual addressing mechanisms that allow the programs of the computer system 300 to behave as if they only have access to a large, single storage entity instead of access to multiple, smaller storage entities. Thus, though the flood analysis component 120 and the ledger 130 are illustrated as being included within the memory 304, components of the memory 304 are not necessarily all completely contained in the same storage device at the same time. Further, although these components are illustrated as being separate entities, in other embodiments some of these components, portions of some of these components, or all of these components may be packaged together.

In an embodiment, the flood analysis component 120 and the ledger 130 include instructions that execute on the processor 302 or instructions that are interpreted by instructions that execute on the processor 302 to carry out the functions as further described in this disclosure. In another embodiment, the flood analysis component 120 and the ledger 130 are implemented in hardware via semiconductor devices, chips, logical gates, circuits, circuit cards, and/or other physical hardware devices in lieu of, or in addition to, a processor-based system. In another embodiment, the flood analysis component 120 and the ledger 130 include data in addition to instructions.

Although the memory bus 303 is shown in FIG. 3 as a single bus structure providing a direct communication path among the CPUs 302, the memory subsystem 304, the display system 306, the bus interface 307, and the input/output bus interface 310, the memory bus 303 can, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the input/output bus interface 310 and the input/output bus 308 are shown as single respective units, the computer system 300 may, in some embodiments, contain multiple input/output bus interface units 310, multiple input/output buses 308, or both. Further, while multiple input/output interface units are shown, which separate the input/output bus 308 from various communications paths running to the various input/output devices, in other embodiments some or all of the input/output devices may be connected directly to one or more system input/output buses.

The computer system 300 may include a bus interface unit 307 to handle communications among the processor 302, the memory 304, a display system 306, and the input/output bus interface unit 310. The input/output bus interface unit 310 may be coupled with the input/output bus 308 for transferring data to and from the various input/output units. The input/output bus interface unit 310 communicates with multiple input/output interface units 312, 314, 316, and 318, which are also known as input/output processors (IOPs) or input/output adapters (IOAs), through the input/output bus 308. The display system 306 may include a display controller. The display controller may provide visual, audio, or both types of data to a display device 305. The display system 306 may be coupled with a display device 305, such as a standalone display screen, computer monitor, television, or a tablet or handheld device display. In alternate embodiments, one or more of the functions provided by the display system 306 may be on board a processor 302 integrated circuit. In addition, one or more of the functions provided by the bus interface unit 307 may be on board a processor 302 integrated circuit.

In some embodiments, the computer system 300 is a multi-user mainframe computer system, a single-user system, or a server computer or similar device that has little or no direct user interface, but receives requests from other computer systems (clients). Further, in some embodiments, the computer system 300 is implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 300. In some embodiments, however, individual components may have greater or lesser complexity than as represented in FIG. 3, Components other than or in addition to those shown in FIG. 3 may be present, and the number, type, and configuration of such components may vary.

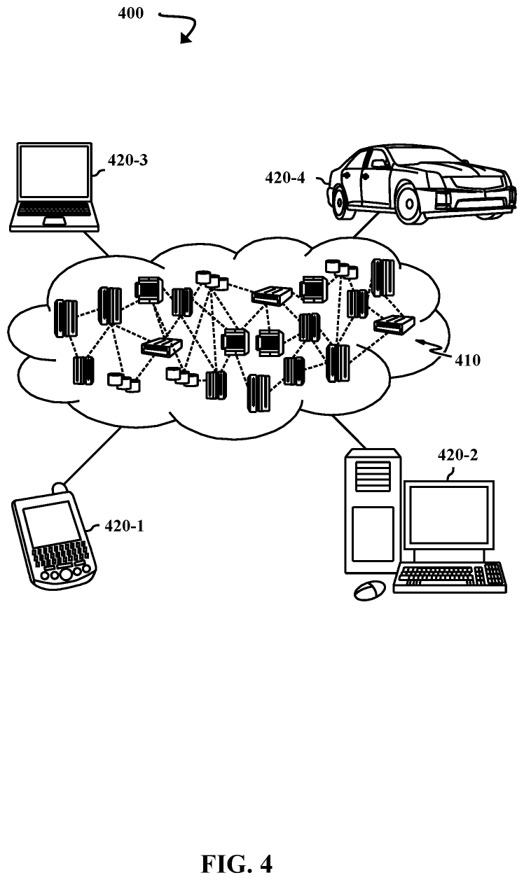

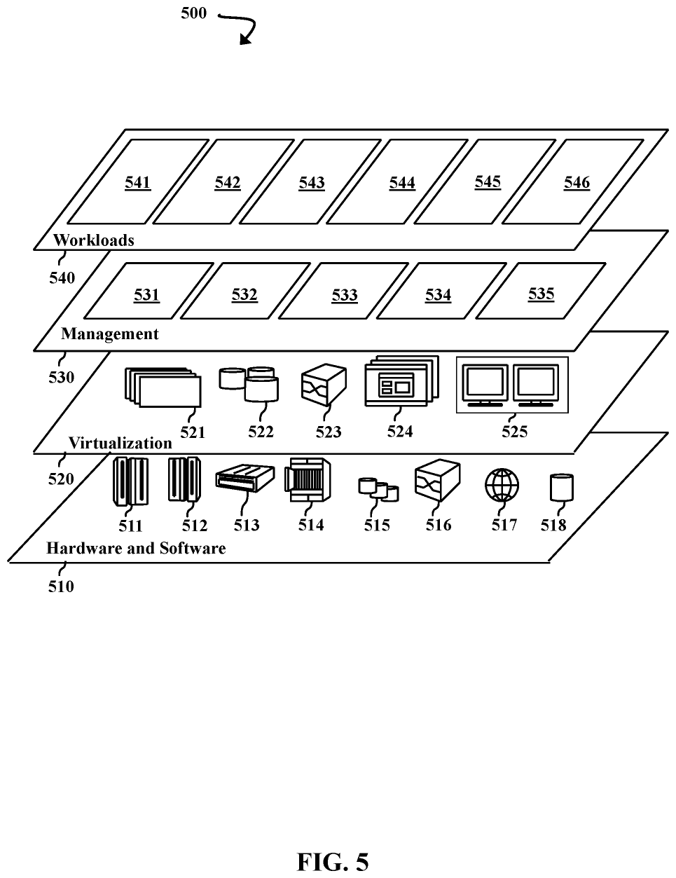

In some embodiments, the data storage and retrieval processes described herein could be implemented in a cloud computing environment, which is described below with respect to FIGS. 4 and 5. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4 is a block diagram illustrating a cloud computing environment 400, according to some embodiments of the present disclosure. As shown, cloud computing environment 400 includes one or more cloud computing nodes 410 with which local computing devices used by cloud consumers, such as, for example, personal digital assistant (PDA) or cellular telephone 420-1, desktop computer 420-2, laptop computer 420-3, and/or automobile computer system 420-4 may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 420-1-420-4 shown in FIG. 4 are intended to be illustrative only and that computing nodes 410 and cloud computing environment 400 can communicate with any type of computerized device over any type of network and/or network addressable connection (e.g., using a web browser).

FIG. 5 is a block diagram illustrating a set of functional abstraction model layers 500 provided by the cloud computing environment 400, according to some embodiments of the present disclosure. It should be understood in advance that the components, layers, and functions shown in FIG. 5 are intended to be illustrative only and embodiments of the invention are not limited thereto. As depicted, the following layers and corresponding functions are provided:

Hardware and software layer 510 includes hardware and software components. Examples of hardware components include mainframes 511; RISC (Reduced Instruction Set Computer) architecture-based servers 512; servers 513; blade servers 514; storage devices 515; and networks and networking components 516. In some embodiments, software components include network application server software 517 and database software 518.

Virtualization layer 520 provides an abstraction layer from which the following examples of virtual entities may be provided: virtual servers 521; virtual storage 522; virtual networks 523, including virtual private networks; virtual applications and operating systems 524; and virtual clients 525.

In one example, management layer 530 provides the functions described below. Resource provisioning 531 provides dynamic procurement of computing resources and other resources that are utilized to perform tasks within the cloud computing environment. Metering and Pricing 532 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 533 provides access to the cloud computing environment for consumers and system administrators. Service level management 534 provides cloud computing resource allocation and management such that required service levels are met. Service Level Agreement (SLA) planning and fulfillment 535 provide pre-arrangement for, and procurement of, cloud computing resources for which a future requirement is anticipated in accordance with an SLA.

Workloads layer 540 provides examples of functionality for which the cloud computing environment can be utilized. Examples of workloads and functions that can be provided from this layer include mapping and navigation 541; software development and lifecycle management 542; virtual classroom education delivery 543; data analytics processing 544; transaction processing 545; and flood data management 546.

The present disclosure may be a system, a method, and/or a computer program product. The computer program product may include a computer readable storage medium (or media) having computer readable program instructions thereon for causing a processor to carry out aspects of the present disclosure.

The computer readable storage medium is a tangible device that can retain and store instructions for use by an instruction execution device. Examples of computer readable storage media can include an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a component, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
at least one processing component;
at least one memory component;
a data manager configured to:
define a ledger for a zone; and
extract flood data for the zone from at least one information source; and
a risk analyzer configured to:
generate flood attribute values based on the extracted flood data;
calculate a zone risk score based on the flood attribute values;
determine that the zone risk score is above a threshold risk score; and
in response to the determining, instruct the data manager to add a block to the ledger.

2. The system of claim 1, wherein the risk analyzer is further configured to calculate a location risk score for a location based on the zone risk score and user-input information about the location.

3. The system of claim 2, further comprising a report generator configured to generate a risk report for the location.

4. The system of claim 2, wherein the user-input information includes a lot drainage type.

5. The system of claim 1, wherein the data manager is further configured to:
extract additional flood data for the zone from the at least one information source; and
wherein the risk analyzer is further configured to:
generate additional flood attribute values based on the additional flood data;
calculate an updated zone risk score based on the additional flood attribute values;
determine that the updated zone risk score is outside a threshold risk score range; and
in response to the determining, instruct the data manager to add a next block to the ledger.

6. The system of claim 1, wherein the at least one information source includes weather data.

7. The system of claim 1, wherein the at least one information source includes insurance claims.

8. A method, comprising:
defining a ledger for a zone;
extracting flood data for the zone from at least one information source;
generating flood attribute values based on the extracted flood data;
calculating a zone risk score based on the flood attribute values;
determining that the zone risk score is above a threshold risk score; and
in response to the determining, adding a block to the ledger.

9. The method of claim 8, further comprising calculating a location risk score for a location based on the zone risk score and user-input information about the location.

10. The method of claim 9, further comprising generating a risk report for the location.

11. The method of claim 9, wherein the user-input information includes a lot drainage type.

12. The method of claim 8, further comprising:
extracting additional flood data for the zone from the at least one information source;
generating additional flood attribute values based on the additional flood data;
calculating an updated zone risk score based on the additional flood attribute values;
determining that the updated zone risk score is outside a threshold risk score range; and
in response to the determining, adding a next block to the ledger.

13. The method of claim 8, wherein the at least one information source includes weather data.

14. The method of claim 8, wherein the at least one information source includes insurance claims.

15. A computer program product, comprising a computer readable storage medium having program instructions embodied therewith, the program instructions executable by a processor to cause a device to perform a method, the method comprising:
defining a ledger for a zone;
extracting flood data for the zone from at least one information source;
generating flood attribute values based on the extracted flood data;
calculating a zone risk score based on the flood attribute values;
determining that the zone risk score is above a threshold risk score; and
in response to the determining, adding a block to the ledger.

16. The computer program product of claim 15, further comprising calculating a location risk score for a location based on the zone risk score and user-input information about the location.

17. The computer program product of claim 16, further comprising generating a risk report for the location.

18. The computer program product of claim 15, further comprising:
extracting additional flood data for the zone from the at least one information source;
generating additional flood attribute values based on the additional flood data;
calculating an updated zone risk score based on the additional flood attribute values;
determining that the updated zone risk score is outside a threshold risk score range; and
in response to the determining, adding a next block to the ledger.

19. The computer program product of claim 15, wherein the at least one information source includes insurance claims.

20. The computer program product of claim 15, wherein the at least one information source includes weather data.
